(19) United States
(12) Patent Application Publication
(10) Pub. No.: US 2010/0109577 A1
(43) Pub. Date: May 6, 2010

(54) CASCADING ADDRESSABLE MASTERING PROTOCOL-BASED LIGHTING SYSTEM

(76) Inventor: James F. LOUGHREY, Stacy, MN (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/613,504

(22) Filed: Nov. 5, 2009

Related U.S. Application Data
(60) Provisional application No. 61/111,564, filed on Nov. 5, 2008.

(51) Int. Cl. H05B 37/00

(52) U.S. Cl. 315/312

(57) ABSTRACT

A method of controlling one or more light fixtures and system thereof are described. Each light fixture is communicably coupled with a lighting control system. The method comprises determining a value of a non-zero portion of a control signal, comparing the determined value with a portion of a component identifier value, and controlling a component corresponding to the component identifier value if the determined value and the portion of the component identifier value are the same.

### BACKGROUND

In the area of lighting control for any system of remote control one of the largest problems has been how to provide master or overall controls for individual fixtures or groups of fixtures. To go to a subordinate (sub) master or a grand master control where you take control of other controllers, has always been a significant problem.

The most common method of remotely controlling fixtures is to use relays or dimmers for individual fixtures and then remote control them with low voltage wires to switches and control panels. This practice is still being done today.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a schematic, high-level block diagram of a lighting system according to an embodiment;

FIG. 2 is a schematic high-level block diagram of a control signal according to an embodiment;

FIG. 3 is a set of exemplary control signals according to an embodiment;

FIG. 4 is a schematic high-level block diagram of a control signal according to another embodiment;

FIG. 5 is a schematic high-level functional block diagram of a computer system according to an embodiment;

FIG. 6 is a schematic high-level functional block diagram of a controller-based system according to an embodiment;

FIG. 7 is a high-level functional flow diagram of a control determination method usable in conjunction with an embodiment;

FIG. 8 is a schematic high-level functional block diagram of a lighting system according to another embodiment; and

FIG. 9 is a high-level functional block diagram of a portion of an exemplary lighting control system according to an embodiment deployed in a building.

### DETAILED DESCRIPTION

One or more embodiments according to the present invention differ from prior known lighting control systems of which the inventor is aware. One or more of the embodiments comprise an architectural design having a form and functions built into the protocol even before any fixtures are assigned to the system.

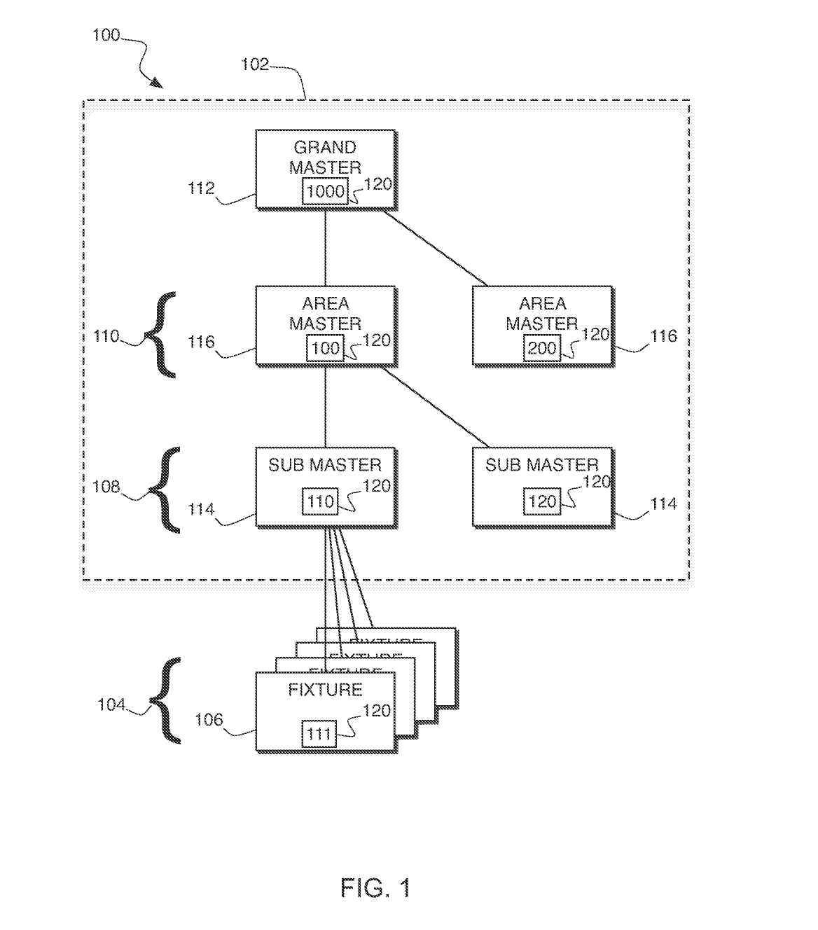

A lighting control system according to an embodiment is referred to as a cascading addressable mastering protocol-based (CAMP-based) lighting control system (also referred to as a CAMP lighting system). FIG. 1 depicts a schematic, high-level block diagram of a CAMP-based lighting system 100 according to an embodiment which includes a CAMP-based lighting control system 102 to which is communicably and controllably coupled a light fixture set 104 comprising one or more individual light fixtures 106.

The communicable coupling between lighting control system 102 and light fixtures 106 may comprise wired and/or wireless connections.

One or more of individual light fixtures 106 comprises one or more of a luminaire, a light source or lamp, and may additionally comprise a ballast or power source/power source connection. In at least some embodiments, light fixture 106 may be positioned external and/or internal to a structure such as a building, fixed, surface-mounted, recessed, or other mounting or placement. In at least some embodiments, light fixture 106 may be a fuel lamp, an arc lamp, an incandescent lamp, a halogen lamp, a gas discharge or high-intensity discharge lamp, a fluorescent lamp, a cold cathode lamp, a fiber optic lamp, an induction lamp, a light-emitting diode or other solid state-based lamp, or a self-powered lamp which is communicably controllable or electrically controllable by lighting control system 102. In response to receipt of a control signal from lighting control system 102, light fixture 106 activates and generates illumination. In at least some embodiments, light fixture 106 activates and generates illumination responsive to receipt of power from lighting control system 102.

In at least some embodiments, the light fixtures 106 in the light fixture set 104 may be individually connected with lighting control system 102. In at least some embodiments, two or more light fixtures 106 in the light fixture set 104 may be jointly connected with lighting control system 102.

In at least some embodiments, a light fixture 106 or light fixture set 104 is understood to include one or more light fixtures to be controlled together.

CAMP-based lighting control system 102 comprises one or more controllers for controlling operation of the light fixtures. In at least some embodiments, the controllers generate and transmit control signals to one or more light fixtures based on user-provided commands, commands received from other devices such as light sensors, timers, etc., or commands received from execution of a computer program on the controller or another device. The controllers comprise a subordinate (sub) master control set 108 (comprising one or more sub master controls 114) communicably coupled with an area master control set 110 (comprising one or more area master controls 116) which, in turn, is communicably coupled with a grand (or overall) master control 112.

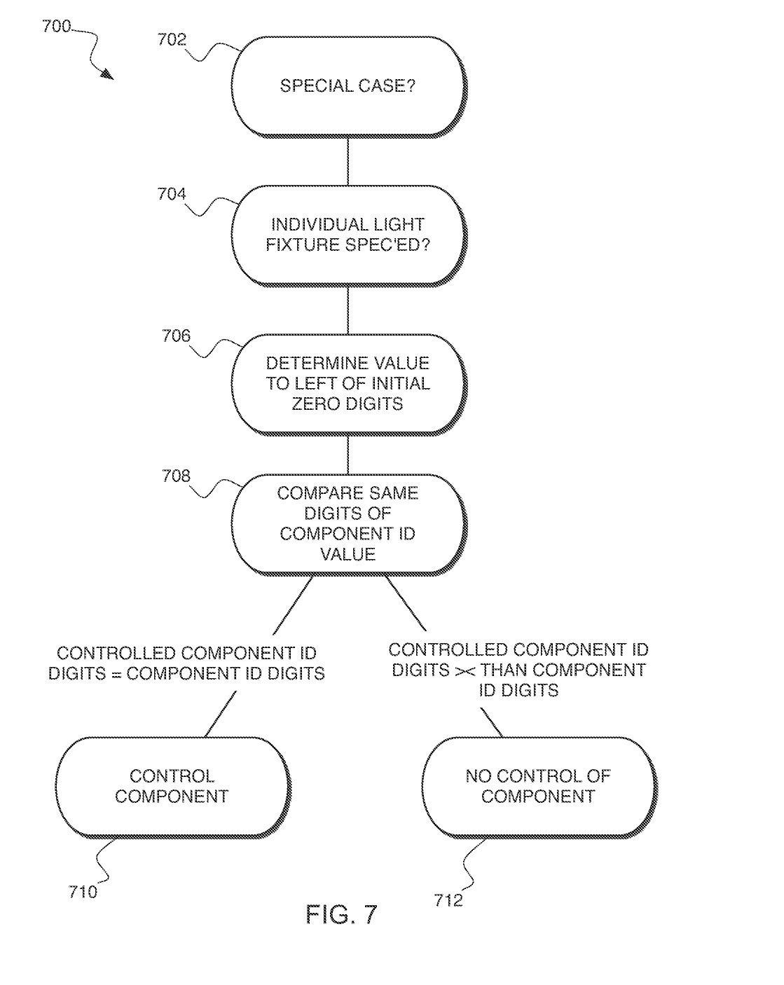

Each light fixture 106 comprises a component identifier 120, e.g., stored in memory. In at least one embodiment, each light fixture 106 is connected with and/or integrated with a ballast comprising a controller or processor-controlled ballast or a switch comprising a controller or processor-controlled switch, e.g., a SwitchGenie ballast or a SwitchGenie Primary switch available from Link Corporation of Stacy, Minn. In at least some embodiments, each ballast controls individual lamps of a light fixture 106 and is configured to turn on and off individual lamps of the light fixture. In at least some embodiments, a switch controlling more than one ballast is configured to turn on or off each ballast and/or all ballasts in a fixture one at a time. In such an embodiment, the switch can control T5 ballasts, compact fluorescent ballasts, metal halide ballasts, light emitting diode ballasts, and magnetic ballasts. In at least some embodiments, one or more light fixtures 106 comprises a switch or ballast comprising a controller-based system 600 (FIG. 6) controlling at least the illumination level of the light fixture.

In at least some embodiments, the switch controls more than one level of illumination per a light fixture 106. In at least some embodiments, an energy saving feature of the switch comprises a default setting to only turn on one lamp or ballast in a light fixture 106 such that an increased power savings results.

In at least some embodiments, component identifier 120 comprises a numeric and/or an alphanumeric sequence of digits. In at least some other embodiments, component identifier 120 comprises additional and/or different sequences of digits.

In at least one embodiment, each of the components comprising lighting control system 102 comprises a component identifier 120. In at least some embodiments, each component identifier stored in a light fixture 106 or other component, e.g., a sub master control 114, an area master control 116, and a grand master control 112, is a unique identifier.

In at least one embodiment, each light fixture 106 comprises a component identifier 120. In accordance with such an embodiment, the remaining components other than the light fixtures need not include a component identifier.

In at least some embodiments, each component identifier 120 is preset and not changeable by a user or another device. In at least some other embodiments, each component identifier 120 is changeable by a user or another device. In at least some embodiments, the component identifier 120 is a serial number of the component in which the identifier is stored.

In at least some embodiments, lighting fixtures 106 have a corresponding logical name in addition to the component identifier 120. In at least some embodiments, the logical name is stored at the lighting fixture, e.g., in a local memory storage. In at least some embodiments, each lighting fixture 106 has a corresponding logical name. In at least some embodiments, the logical name is user-assignable and modifiable. In at least some embodiments, each component of lighting control system 102 has a corresponding logical name which is user-assignable and modifiable.

In at least some embodiments, the corresponding logical name(s) are assigned and stored at a computer system external to, but in communication with, one or more of the lighting control system 102 or one or more of light fixtures 106.

Sub master control set 108 comprises one or more individual sub master controls 114. In turn, each sub master control 114 is communicably coupled with one or more light fixture 106 and/or one or more light fixture sets 104. Sub master control 114 comprises a component identifier 120. Sub master control 114 controls one or more of light fixtures 106 and/or one or more light fixture sets 104 to set an illumination level of the light source connected thereto. In at least some embodiments, sub master control 114 transmits a light control signal comprising light control information to a light fixture 106 or light fixture set 104 to set the illumination level. In at least some embodiments, the light control signal comprises unique light fixture identifying information, e.g., a component identifier 120 of the light fixture. In at least some embodiments, the light control signal comprises light fixture identifying information which applies to more than one light fixture, e.g., an identifier which applies to more than one light fixture 106. In at least some embodiments, different levels of illumination or light output are controlled by a sub master control 114 including illumination level specifying information in the light control signal. In at least some embodiments, sub master controls 114 do not have a component identifier 120.

Area master control set 110 comprises one or more individual area master controls 116. In turn, each area master control 116 is communicably coupled with one or more sub master controls 114 of sub master control set 108. Area master control 116 controls one or more of sub master controls 114 to cause the sub master control to control one or more of light fixtures 106 and/or one or more light fixture sets 104. In at least some embodiments, area master control 116 transmits a light control signal to light fixtures and other lower level controllers, i.e., sub master controls.

In at least some embodiments, area master control 116 transmits a sub master control signal, i.e., a light control signal generated and transmitted from the area master control 116, comprising sub master control information to a sub master control 114 for transmission to light fixture 106 or light fixture set 104 to set an illumination level. In at least some embodiments, the sub master control signal comprises unique sub master identifying information, e.g., a component identifier 120 of the sub master control 114. In at least some embodiments, the sub master control signal comprises unique light fixture identifying information, e.g., a component identifier 120 of a specific light fixture 106. In at least some embodiments, the sub master control signal comprises unique sub master identifying information and unique light fixture identifying information. In at least some embodiments, the sub master control signal comprises sub master control identifying information which applies to more than one sub master control, e.g., an identifier which applies to more than sub master control 114. In at least some embodiments, different levels of illumination or light output are controlled by an area master control 116 including illumination level specifying information in the sub master control signal. In at least some embodiments, area master controls 114 do not have a component identifier 120.

Grand master control 112 is a singular control node for controlling each element of each level cascaded below the grand master control, e.g., area master controls 116, sub master controls 114, and/or light fixtures 106. The grand master control 112 is communicably coupled with each of the area master controls 116 in area master control set 110. Grand master control 112 controls one or more of area master controls 116 to cause the area master control to control one or more of sub master controls 114 and therein control one or more of light fixtures 106 and/or one or more light fixture sets 104. In at least some embodiments, grand master control 112 transmits a light control signal to light fixtures and other lower level controllers, i.e., area master controls and sub master controls. Grand master control 112 comprises a component identifier 120. In at least some embodiments, grand master control 112 lacks a component identifier 120.

In at least some embodiments, grand master control 112 transmits an area master control signal, i.e., a light control signal generated and transmitted from the grand master control 112, comprising area master control information to an area master control 116. In at least some embodiments, the area master control signal comprises unique area master identifying information, unique sub master identifying information, and/or unique light fixture and/or light fixture set identifying information or a combination thereof, e.g., one or more component identifiers 120 of the appropriate components. In at least some embodiments, the area master control signal comprises area master control identifying information which applies to more than one area master control, e.g., an identifier which applies to more than one component. In at least some embodiments, different levels of illumination or light output controlled by the grand master control 112 including illumination level specifying information in the area master control signal.

In at least some embodiments, one or both of area master controls 116 or sub master controls 114 are not present in a lighting control system. In accordance with this particular embodiment, grand master control 112 is communicably coupled with light fixtures 106 and controls light fixtures 106 as described above for sub master controls 114. In at least some other embodiments, lighting control system 102 comprises more intermediate levels of controls between grand master control 112 and light fixtures 106, e.g., additional levels of controls similar to area master control 116 and/or sub master control 114 are communicably coupled between the components of lighting control system 102.

In at least some embodiments, lighting control system 102 comprises greater or fewer number of controller levels, e.g., additional levels beyond sub master control set 108, area master control set 110. For example, a particular lighting control system may comprise zone controllers, floor controllers, etc.

In at least some embodiments, one or more of sub master controls 114, area master controls 116, and/or grand master control 112 are virtual devices comprising one or more software executable objects stored and executed by a computer system in communication with, or as a part of, lighting control system 102. In at least some other embodiments, one or more of sub master controls 114, area master controls 116, and/or grand master control 112 are physical switches, keyed in addresses on computers, wireless devices, or sensors having keyed addresses stored therein or similar devices.

In at least some embodiments, one or more of sub master controls 114, area master controls 116, and/or grand master control 112 are wired and/or wirelessly connected.

In at least some embodiments, component identifiers 120 are only assigned to light fixtures 106.

In at least one embodiment, an individual light fixture 106 is communicably coupled with more than one sub master control 114.

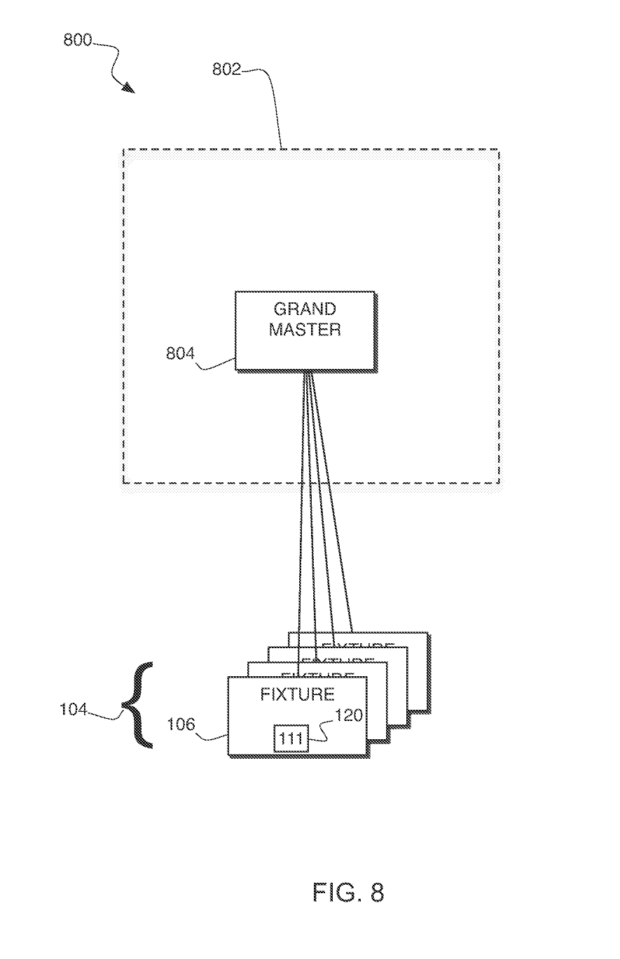

FIG. 8 depicts a schematic, high-level block diagram of a CAMP-based lighting system 800 according to another embodiment which includes a simplified CAMP-based lighting control system 802 to which is communicably and controllably coupled the light fixture set 104 comprising one or more individual light fixtures 106. Lighting control system 802 comprises a grand master controller 804 communicably coupled with the lighting fixtures 106. In accordance with the simplified lighting control system 802, the grand master control 804 directly controls the light fixtures 106 connected to the control. In at least some embodiments, grand master control 804 responds to received commands from a user manipulating the control. In at least some other embodiments, the grand master control 804 responds to received commands from a computer system external to, but communicably coupled with, the lighting control system 802.

In at least one embodiment, a basic design of the lighting control system 102 is a pyramid having grand master control 112 at the top of the pyramid. Continuing down from the top of the pyramid, each level downward provides another opportunity to have mastering capability over the components in the levels below. In at least some embodiments, the cascading control hierarchy is fixed based on the assignment of component identifiers to light fixtures or groups of fixtures and automatically incorporates the availability of master controls, e.g., sub master controls, area master controls, etc., to the lighting control system without requiring software or hardware adjustments. In at least these embodiments, the control hierarchy comprising the master controls is available for use by one or more master controls connected with the lighting system at a level above the light fixture sets 104 or light fixtures 106.

In at least some embodiments, lighting control system 102 is extended to comprise the light fixture set 104 and thus the bottom of the pyramid comprises the lights and/or light fixtures to be controlled. In at least some embodiments, the bottom level may comprise individual light fixtures 106 or groups of lighting fixtures, e.g. light fixture set 104, comprising a plurality of light fixtures in the group. In at least some embodiments, a light fixture group may comprise twenty (20) or more light fixtures in a group.

Lighting control system 102 comprises a cascaded sequence of levels of control, i.e., grand master control 112, area master control set 110, and sub master control set 108. Grand master control 112 controls one or more of area master controls 116 in area master control set 110. An area master control 116 controls one or more of sub master controls 114 in sub master control set 108. A sub master control 114 controls one or more of light fixtures 106 in light fixture set 104.

In at least some embodiments, the size of the installation location in which lighting control system 102 and light fixtures 106 are installed along with the number of controls, e.g., groupings of light fixtures, sub master controls, area master controls, etc., is a basis for the determination of the control scheme used in the cascading control system. For example, depending on the number of control groupings more or less digits may be used to form the component identifier 120.

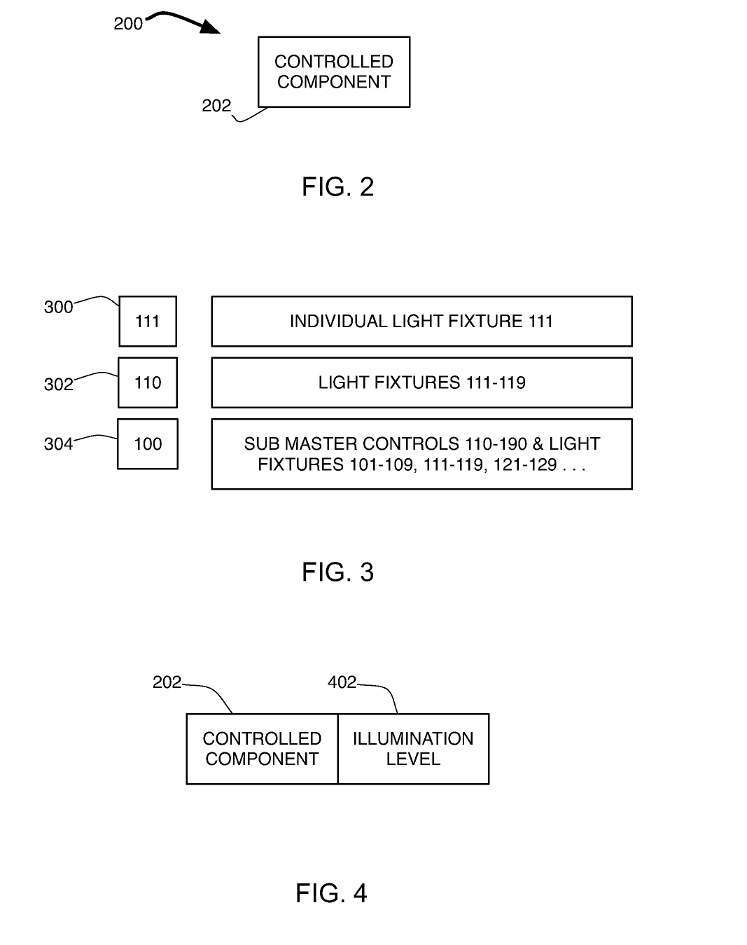

FIG. 2 depicts a schematic high-level diagram of a light control signal 200, e.g., as transmitted from a sub master control 114 to a light fixture 106, from an area master control 116 to a sub master control 114, or from a grand master control 112 to an area master control 116. Light control signal 200 comprises a controlled component identifier 202 identifying the particular component and/or components to be controlled by the light control signal. By selecting an appropriate value for the controlled component identifier 202 one or more components are controlled. In the FIG. 2 embodiment, light control signal 200 causes an activation/deactivation, i.e., turning on or off, of a particular identified component.

Controlled component identifier 202 identifies either a particular component through the specification of the component identifier of the component to be controlled or a range of components through the specification of a value within which one or more components component identifiers are determined to exist.

In accordance with one exemplary embodiment, components having component identifier values ending in zero (0) control components having successive component identifier values in sequence until the next value ending in zero (0). Additionally according to this embodiment, components having component identifier values ending in double zero (00) control components having successive component identifier values in sequence until the next value ending in double zero (00). The scheme continues such that components having component identifier values ending in triple zero (000) control components having successive component identifier values in sequence until the next value ending in triple zero (000). The scheme continues in accordance with this sequence. In accordance with another exemplary embodiment, components at a level above the light fixtures are not assigned component identifiers instead the components generate a light control signal (described in further detail below) in accordance with the above-described numbering scheme.

FIG. 3 depicts an exemplary set of light control signals 200 transmitted via grand master control 112 in lighting control system 102. A first light control signal 300 comprises a controlled component identifier value of “111” which corresponds to a control signal indicating control of an individual light fixture having a component identifier 120 having a value of “111”. A second light control signal 302 comprises a controlled component identifier value of “110” which corresponds to a control signal indicating control of a set of individual light fixtures having component identifier values within the range of “111” through “119”. A third light control signal 304 comprises a controlled component identifier value of “100” which corresponds to a control signal indicating control of a set of sub master controls having component identifier values within the range of “101” and “199”, i.e., sub master controls having component identifier values “110”, “120”, “130”, “140”, “150”, “160”, “170”, “180”, “190”, and a set of light fixtures having component identifier values within the same range, i.e., light fixtures having component identifier values “101-109”, “111-119”, “121-129”, “131-139”, “141-149”, “151-159”, “161-169”, “171-179”, “181-189”, and “191-199”.

In at least some embodiments, light control signal 200 comprises the digits needed to specify the components to be controlled.

FIG. 4 depicts a schematic high-level diagram of a control signal 400 according to another embodiment in which the control signal comprises an illumination level 402 at which the component identified by the controlled component identifier 202 is to be set. In at least some embodiments, illumination level 402 comprises a value indicative of at least an on or off setting. In at least some other embodiments, illumination level 402 comprises a value indicative of two or more illumination levels.

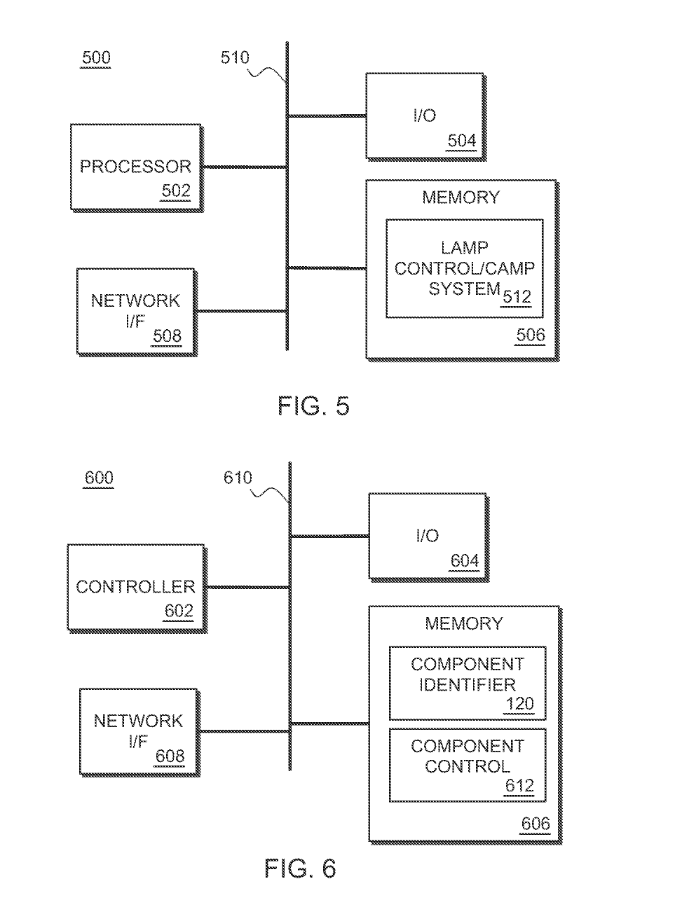

FIG. 5 depicts a high-level functional block diagram of a computer system 500 usable in conjunction with an embodiment. Computer system 500 comprises a processor 502 (alternatively referred to as a processing or controller-based device), a memory 506, a network interface (I/F) 508, and an input/output device 504 communicatively coupled via a bus 510 or other interconnection communication mechanism.

Memory 506 (also referred to as a computer-readable medium) may comprise a random access memory (RAM) or other dynamic storage device, coupled to the bus 510 for storing data and/or instructions to be executed by processor 502. Memory 506 also may be used for storing temporary variables or other intermediate information during execution of instructions to be executed by processor 502. Memory 506 may also comprise a read only memory (ROM) or other static storage device coupled to the bus 510 for storing static information and instructions for the processor 502.

In at least some embodiments, memory 506 also stores a copy of the component identifier for each component controller and a user-readable name and/or number corresponding to the component identifier value. In at least some embodiments, the user-readable name and/or number may be user-assignable.

Network I/F 508 comprises a mechanism for connecting to a network and/or lighting control system 102. In at least some embodiments, computer system 102 comprises more than a single network interface. In at least some embodiments, network I/F 508 may comprise a wired and/or wireless connection mechanism. In at least some embodiments, computer system 500 connects with lighting control system 102 via bus 510 and/or I/O 504.

A storage device, such as a magnetic disk, optical disk, or electromagnetic disk, may also be provided and coupled to the bus 510 for storing data and/or instructions.

Lamp control/CAMP system 512 comprises a set of executable instructions which, when executed by processor 502, cause the processor to provide lamp control system and/or a CAMP lighting control system according to an embodiment. In at least some embodiments, lamp control/CAMP system 512 execution by processor 502 causes the display of a user interface to a user of computer system 500 either via I/O device 504 or network I/F 508.

I/O device 504 may comprise an input device, an output device and/or a combined input/output device for enabling user interaction. An input device may comprise, for example, a keyboard, keypad, mouse, trackball, trackpad, and/or cursor direction keys for communicating information and commands to processor 502. An output device may comprise, for example, a display, a printer, a voice synthesizer, etc. for communicating information to a user. In at least some embodiments, I/O device 504 may comprise a serial and/or parallel connection mechanism for enabling the transfer of one or more of files and/or commands. In at least some embodiments, I/O device 504 is an optional component of computer system 500.

FIG. 6 depicts a schematic high-level functional block diagram of a controller-based system 600 usable in conjunction with an embodiment of one or more controls of lighting control system 102, i.e., grand master control 112, area master control 116, and/or sub master control 114, or a control as part of a light fixture 106. Controller-based system 600 comprises a controller 602 (alternatively referred to as a processor or processing device), a memory 606, a network interface (I/F) 608, and an input/output device 604 communicatively coupled via a bus 610 or other interconnection communication mechanism.

Memory 606 (also referred to as a computer-readable medium) may comprise a random access memory (RAM) or other dynamic storage device, coupled to the bus 610 for storing data and/or instructions to be executed by controller 602. Memory 606 also may be used for storing temporary variables or other intermediate information during execution of instructions to be executed by controller 602. Memory 606 may also comprise a read only memory (ROM) or other static storage device coupled to the bus 610 for storing static information and instructions for the controller 602. Memory stores component identifier 120 and a set of executable instructions comprising component control 612.

Component control 612 comprises a set of instructions which, when executed by controller 602 cause the controller to operate in response to receipt of one or more commands received, for example, via network I/F 608 or I/O device 604. In at least one embodiment, component control 612 operates responsive to receipt of a light control signal such as control signal 200 or control signal 400. In at least some embodiments, memory 606 also stores an illumination level of a light fixture to which controller 600 is connected.

Network I/F 608 comprises a mechanism for connecting to a network and/or lighting control system 102. In at least some embodiments, computer system 102 comprises more than a single network interface. In at least some embodiments, network I/F 608 may comprise a wired and/or wireless connection mechanism. In at least some embodiments, computer system 600 connects with lighting control system 102 via bus 610 and/or I/O 604. In at least some embodiments, network I/F 608 may be connected to a packet-based interconnected network of devices such as an internet or the worldwide packet-switched network known as the Internet. In at least one embodiment, a computer system such as computer system 500 (FIG. 5) may be connected via a network to a controller-based system 600 to control operation of lighting system 102.

A storage device, such as a magnetic disk, optical disk, or electromagnetic disk, may also be provided and coupled to the bus 610 for storing data and/or instructions.

I/O device 604 may comprise an input device, an output device and/or a combined input/output device for enabling user interaction. In at least some embodiments, I/O device 604 comprises a connection with light fixture 106. An input device may comprise, for example, a keyboard, keypad, mouse, trackball, trackpad, and/or cursor direction keys for communicating information and commands to controller 602. An output device may comprise, for example, a display, a printer, a voice synthesizer, etc. for communicating information to a user. In at least some embodiments, I/O device 604 may comprise a serial and/or parallel connection mechanism for enabling the transfer of one or more of files and/or commands. In at least some embodiments, I/O device 604 is an optional component of controller-based system 600.

In previous systems of which the inventor is aware, the mastering control of the individual fixtures is accomplished by using diodes and wires going to switches to control the groups of lights.

With the low voltage relays that are often industry standard, computers are used to do time clock control, motion sensing and daylight harvesting but all of this requires control wires from the devices to the master control panel.

In at least some embodiments, the present lighting control system 102 is embedded in the switch or ballast controlling components, e.g., SwitchGenie products. In at least some embodiments, the system works with dedicated low voltage control wire that utilizes 4 conductor telephone cable with polarized RJ11 connectors or operates with radio frequency (RF) wireless controls. The RF system in accordance with at least one embodiment is based on the MiWi protocol. The lighting system protocol is also embedded in RF wireless transceivers so that the transceivers comprise more than “wire eliminators”. At least some embodiments, comprise intelligent nodes performing functions to make the lighting system respond to current or memorized commands and may be configured to work with or without a computer input or server support.

FIG. 7 depicts a high-level functional flow diagram of a control determination method 700 usable in conjunction with an embodiment. Control determination method 700 comprises a set of executable or interpretable instructions which, when executed by a controller or processor, e.g., controller 602 (FIG. 6), causes the controller to determine whether to control the illumination level of the device to which the controller is connected.

The process flow begins at functionality 702 wherein the value of the controlled component identifier 202 of a received control signal 200 is evaluated to determine whether a special case applies. In at least one embodiment, a special case is determined to exist with respect to a controlled component identifier 202 in which there are no non-zero digits in the value, i.e. the controlled component identifier comprises one or more zeros. In accordance with this particular embodiment, if controlled component identifier 202 comprises no non-zero digits, each component controlled by the controller executing control determination method 700 is turned off. In accordance with another particular embodiment, if controlled component identifier 202 comprises no non-zero digits, each component controlled by the controller executing control determination method 700 is turned on. In at least some other particular embodiments, if controlled component identifier 202 comprises no non-zero digits, the illumination level of each component controlled by the controller executing control determination method 700. The flow of control then proceeds to end and no further processing according to control determination method 700 is performed.

In at least some other embodiments, further special cases may be applied with respect to the receipt of preset controlled component identifiers 202. For example, a controlled component identifier value of “000” or all zeroes may be used to indicate turning on or off of all light fixtures. Alternatively, a controlled component identifier value of “10000” may be used to indicate turning on or off of all light fixtures or a specified one or more subset of light fixtures.

If a special case does not apply the flow of control proceeds to functionality 704 and execution of the method determines whether an individual light fixture 106 is specified by controlled component identifier 202. The determination of functionality 704 is performed by determining whether the right-most digit of the controlled component identifier is a non-zero value. For example, given a controlled component identifier 202 value of “321”, the right-most digit is “1” thereby indicating control of an individual light fixture. If an individual light fixture is specified by controlled component identifier 202 and the controller executing control determination method 700 is connected to and controlling the specified light fixture, the controller controls illumination of the light fixture. In at least some embodiments, a given controller controlling illumination of a light fixture may cause one or more of turning on, turning off, or setting an illumination level of the light fixture. The flow of control then proceeds to end and no further processing according to control determination method 700 is performed.

If an individual light fixture is not specified, the flow of control proceeds to functionality 706 and execution of the method determines the value to the left of the initial zero value digits. For example, given a controlled component identifier 202 value of “320”, the value to the left of the initial zero value digits is “32”. The flow of control then proceeds to functionality 708 and execution of the method compares the value of the digits of the same placement in the component identifier 120 of the light fixture with the value determined in functionality 706. For example, given a component identifier 120 value of “221” and a controlled component identifier 202 value of “320”, functionality 708 execution causes the comparison of the value “32” determined from functionality 706 with the value “22” determined from the corresponding digits, i.e., the first and second digits from the left of the component identifier value corresponding to the digit places determined in functionality 706.

In another example, given a component identifier 120 value of “555” and a controller component identifier 202 value of “500” (causing functionality 706 execution to determine a value of “5”), functionality 708 execution causes the comparison of the value “5” from the component identifier value with the value “5” from functionality 706. Because the compared values are the same, the flow proceeds to functionality 710 and the light fixture is controlled.

In still another example, given a component identifier 120 value of “919” and a controller component identifier 202 value of “550” (causing functionality 706 execution to determine a value of “55”), functionality 708 execution causes the comparison of the value “91” from the component identifier value with the value “55” from functionality 706. Because the compared values differ, the flow proceeds to functionality 71 and the light fixture is not controlled.

If the compared values are the same, the flow of control proceeds to functionality 710 and the controller executing control determination method 700 controls illumination of the light fixture to which the controller is connected. In at least some embodiments, a given controller controlling illumination of a light fixture may cause one or more of turning on, turning off, or setting an illumination level of the light fixture. The flow of control then proceeds to end and no further processing according to control determination method 700 is performed.

In at least some embodiments, the control signal received may comprise an illumination level identifier 402 (FIG. 4) specifying a particular illumination level to which the light fixture is to be controlled.

If the compared values differ, the flow of control proceeds to functionality 712 and the controller executing control determination method 700 does not control illumination of the light fixture to which the controller is connected.

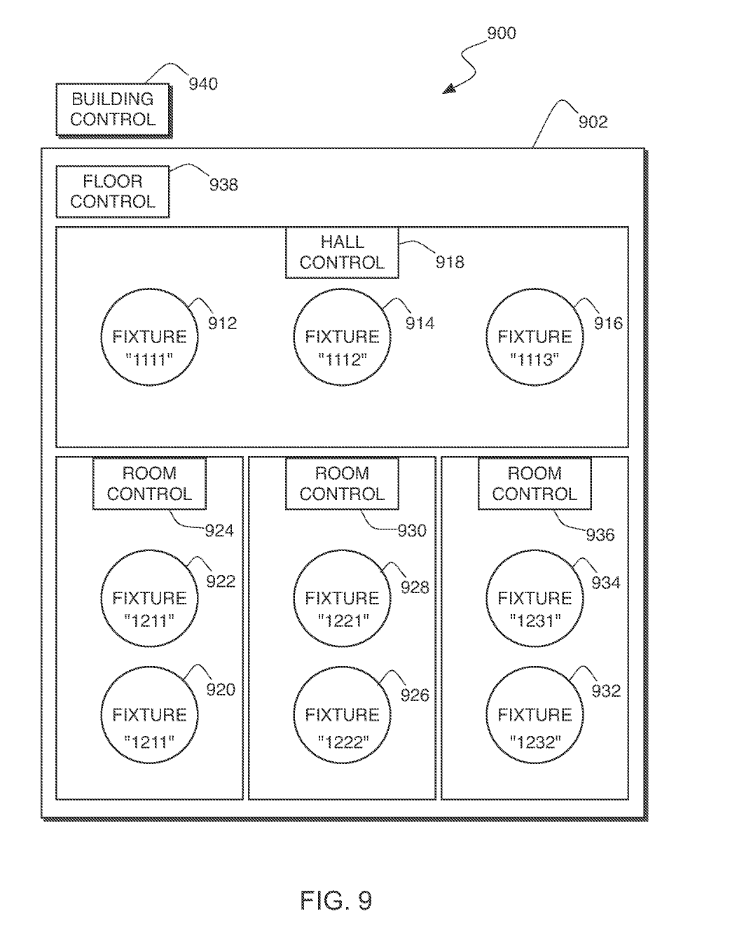

FIG. 9 is a high-level functional block diagram of at least a portion of an exemplary lighting control system according to an embodiment deployed in a building 900.

Building 900 comprises at least one floor 902 having a hall area 904 and three rooms 906, 908, 910 each in communication with the hall area. Hall area 904 comprises three light fixtures 912, 914, 916 and a hall control 918. Room 906 comprises two light fixtures 920, 922, and a room control 924. Room 908 comprises two light fixtures 926, 928 and a room control 930. Room 910 comprises two light fixtures 932, 934 and a room control 936. Floor 902 comprises the hall area 904 and the three rooms 906, 908, 910 and a floor control 938. Building 900 comprises at least floor 902 and a building control 940.

Each of the light fixtures on floor 902 is electrically connected to a power source, e.g., a mains power source. Each of the light fixtures on floor 902 comprises a controller as described above, i.e., controller 600 (FIG. 6), in which is stored a unique component identifier. The light fixture controller controls the level of illumination generated by the light fixture in accordance with the control determination method described above and in conjunction with the process flow depicted in FIG. 7.

In accordance with the depicted embodiment of FIG. 9, the assigned component identifiers for the three light fixtures 912, 914, 916 in the hall area 904 are “1111”, “1112”, “1113”, respectively. The assigned component identifiers for the two light fixtures 920, 922 in the room 906 are “1211”, “1212”, respectively. The assigned component identifiers for the two light fixtures 926, 928 in the room 908 are “1221”, “1222”, respectively. The assigned component identifiers for the two light fixtures 932, 934 in the room 910 are “1231”, “1232”, respectively.

Each of the controls, i.e. room controls 924, 930, 936, hall control 918, floor control 938, and building control 940, are configured to generate a light control signal comprising a controlled component identifier 202, as described above. In at least some embodiments, one or more of the controls comprise one or more user input mechanisms, e.g., a wall switch, a keypad, or other controlling mechanisms, to enable a user to input one or more commands to control the illumination of one or more fixtures. In at least some embodiments, one or more of the controls comprise one or more programs and/or input devices such as sensors, timers etc. to cause the control to generate the light control signal.

In at least some embodiments, one or more of the controls is connected with one or more light fixtures via a wired and/or wireless connection to communicate the light control signal to the one or more light fixtures.

In at least some embodiments, building 900 comprises more than one floor and greater or fewer hall areas and rooms and corresponding controls.

In a given particular scenario, room control 924 is configured to generate a light control signal in which the controlled component identifier 202 is “1210”. In operation, activation of room control 924 by a user, e.g., manipulation of a switch on a wall of the room, causes the room control to generate and transmit a light control signal to light fixtures 920, 922 where the controlled component identifier 202 is “1210”. In accordance with the control determination method (FIG. 7), upon receipt of the light control signal from room control 924, light fixture 922 and light fixture 920 activate and generate illumination based on the matching digits between the light fixture component identifiers and the controlled component identifier digits, i.e., “121” of “1211” and “1212” and “121” of “1210”.

In another given particular scenario, room control 930 is configured to generate a light control signal in which the controlled component identifier 202 is either “1221” or “1222” based on a received user input, e.g., a user manipulation of two wall switches connected to the room control. In operation, activation of room control 930 by a user, e.g., manipulation of a switch on a wall of the room, causes the room control to generate and transmit a light control signal to light fixtures 926, 928 where the controlled component identifier 202 is “1221”. In accordance with the control determination method (FIG. 7), upon receipt of the light control signal from room control 930, light fixture 928 activates and generates illumination based on the specified controlled component identifier digits, i.e., “1221” matching at functionality 704 in light fixture 928 execution of the control determination method (FIG. 7). Also, in accordance with the control determination method, upon receipt of the light control signal from room control 930, light fixture 926 does not activate because the specified controlled component identifier digits do not match the component identifier of light fixture 926.

In another given particular scenario, floor control 938 is configured to generate a light control signal in which the controlled component identifier 202 is one of “1000”, “1100”, “1200” in response to user manipulation of a user input mechanism, e.g., a selection of one of three switches. In operation, manipulation of floor control 938 by a user causes activation or deactivation of illumination by light fixtures 912, 914, 916 by generation and transmission of a light control signal comprising the controlled component identifier value of “1100”. Alternatively, manipulation of floor control 938 by a user causes activation or deactivation of illumination by light fixtures 920, 922, 926, 928, 932, 934 by generation and transmission of a light control signal comprising the controlled component identifier value of “1200”. Further alternatively, manipulation of floor control 938 by a user causes activation or deactivation of illumination by the light fixtures on floor 902 a generation and transmission of a light control signal comprising the controlled component identifier value of “1000”.

In another given particular scenario, building control 940 is configured to generate a light control signal in which the controlled component identifier 202 is “0000”. In operation, manipulation of building control 940 by a user causes activation or deactivation of illumination by all the light fixtures in building 900 by generation and transmission of a light control signal comprising the controlled component identifier value of “0000”.

In at least some embodiments, building control 940 is configured to generate a light control signal in which the controlled component identifier 202 value includes each of the controlled component identifier values of the floor controls in building 900, e.g., “1000” corresponding to a first floor floor control, “2000” corresponding to a second floor floor control, etc.

In accordance with at least one embodiment, one or more of the controlled component identifiers included in the light control signal generated by one of the controls, i.e., building control 940, floor control 938, hall control 918, or room controls 924, 930, 936, may be changed based on a changed light fixture layout, room layout, floor layout, hall layout or other physical or logical configuration and/or control scheme change. In such an embodiment, the control of the light fixtures is changeable by changing either or both of the assigned light fixture component identifiers and/or the controlled component identifier(s) generated by the controls without necessitating a change of communication paths or the control determination method or instructions executed by a controller in the light fixtures.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. A system for controlling one or more light fixtures comprising:
one or more light fixtures communicably coupled with one or more sub master controls, each of the one or more light fixtures comprising a unique component identifier;
each of the one or more sub master controls comprising a control determination method responsive to receipt of a control signal comprising a controlled component identifier to control one or more of the light fixtures based on execution of the control determination method.

2. The system as claimed in claim 1, comprising:
one or more sub master controls communicably coupled with one or more area master controls, each of the one or more sub master controls comprising a unique component identifier;
each of the one or more area master controls comprising a control determination method responsive to receipt of the control signal comprising a controlled component identifier to control one or more of the sub master controls.

3. The system as claimed in claim 2, comprising:
one or more area master controls communicably coupled with a grand master control, each of the one or more area master controls comprising a unique component identifier;
the grand master control comprising a control determination method responsive to receipt of the control signal comprising a controlled component identifier to control one or more of the area master controls.

4. The system as claimed in claim 1, the control signal further comprising an illumination level identifier.

5. A system for controlling one or more light fixtures comprising:
a light fixture comprising a controller, the controller comprising one or more executable instructions which, when executed, cause the controller to perform a control determination method, the controller also comprising a component identifier; and
a master control communicably coupled with the light fixture and configured to generate and transmit a light control signal to the light fixture to control illumination of the light fixture.

6. The system as claimed in claim 5, the light control signal comprising a controlled component identifier.

7. The system as claimed in claim 6, the control determination method comprising instructions which, when executed, control illumination of the light fixture based on the controlled component identifier.

8. The system as claimed in claim 6, the light control signal further comprising an illumination level identifier.

9. A method of controlling one or more light fixtures, each light fixture communicably coupled with a lighting control system, the method comprising:
determining a value of a non-zero portion of a control signal;
comparing the determined value with a portion of a component identifier value; and
controlling a component corresponding to the component identifier value if the determined value and the portion of the component identifier value are the same.

10. The method as claimed in claim 9, comprising:
not controlling a component corresponding to the component identifier value if the determined value and the portion of the component identifier value differ.

11. A memory or a computer-readable medium storing instructions which, when executed by a processor, cause the processor to perform the method of claim 9.
